(19) United States
(12) Patent Application Publication
(10) Pub. No.: US 2008/0259210 A1
(43) Pub. Date: Oct. 23, 2008

(54) Audiovisual Display Apparatus and Method

(76) Inventors: Gorka Garcia, Madrid (ES); Nicholas D.L. Thorne, Southampton (GB); Christopher L. Norman, Southampton (GB)

Correspondence Address: NXP, B.V.;NXP INTELLECTUAL PROPERTY DEPARTMENT, M/S41-SJ, 1109 MCKAY DRIVE, SAN JOSE, CA, 95131, US

(21) Appl. No.: 10/594,015

(22) PCT Filed: Mar. 22, 2005
(86) PCT No.: PCT/IB05/50974

§ 371 Date: May 2, 2008

(30) Foreign Application Priority Data
Mar. 23, 2004 (GB) 0406442.4

(51) Int. Cl. H04N 7/00

(52) U.S. Cl. 348/462; 348/E07.001

(57) ABSTRACT

The invention provides for an audio visual display apparatus (10) arranged to receive a broadcast signal comprising a video element and an audio element, wherein the audio element includes an audio description element providing a description of at least some of the video content, the apparatus (10) including means for switching (24) to output the said audio description element in place of the video element and which switching is responsive to a deterioration in an operating characteristic of the apparatus.

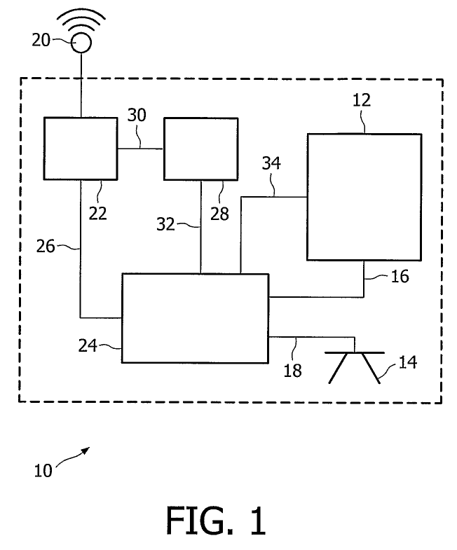

The present invention relates to an audiovisual display apparatus and related method and, in particular, to a relatively small handheld mobile audiovisual display apparatus.

Power requirement and power consumption figures within an electronic device such as audio visual display apparatus are becoming increasingly important due to the increased desire for mobile devices and also, in order, to improve general operating efficiency.

Currently known audio visual display devices exhibit disadvantages insofar as they expend power on service aspects which may not prove appropriate, or may not prove to be fully available, due, for example, to limitations within the device itself, limitations in the quality of the signal received and also having regard to the level of battery power that may be remaining at any particular time.

The invention seeks to provide for an audiovisual display apparatus, and related method of operation, and which exhibit advantages over known such apparatus and methods.

According to a first aspect of the present invention, there is provided an audio visual display apparatus arranged to receive a broadcast signal comprising a video element and an audio element, wherein the audio element includes an audio description element providing a description of at least some of the video content, the apparatus including means for switching to output the said audio description element in place of the video element in response to a deterioration in an operating characteristic associated with the apparatus.

The apparatus can prove advantageous in providing for the disabling of the video output in a manner responsive to particular operating characteristics.

The invention can then, when required, reduce power consumption within the apparatus whilst providing for a suitable output for the user by means of the audio description element.

Advantageously, the apparatus includes means for monitoring the said operating characteristics.

The said means for monitoring can advantageously be arranged to monitor battery level within the apparatus so as to switch from video output to output of the audio description element when battery level has dropped to a threshold value so as to thereafter conserve power within the apparatus.

Alternatively, or in addition, the means for monitoring the characteristic can be arranged to monitor available data-handling capacity within the apparatus. Current memory capacity can therefore be monitored so as to allow for the processing of the audio description element, rather than video content, which can prove advantageous in continuing desired operation of the apparatus but with only a limited memory capacity.

Yet further, the means for monitoring the operating characteristic can be arranged to monitor the quality of the broadcast signal as received at the apparatus and so as to provide for switching to output of the audio description element should an unsuitably poor quality of received signal be detected.

Advantageously, the means for monitoring the characteristic can be arranged to monitor the picture quality of the video element.

It will be appreciated that the invention provides specifically advantageous for use as a mobile audiovisual display apparatus which can comprise, if required, a mobile television apparatus and/or a mobile radio communications device such as cellular phone arranged for receipt of a broadcast including a video element.

The apparatus can, in particular, be advantageously employed within a digital broadcast system and the audio description element can advantageously be arranged to be transmitted within, and extracted from, an audio channel separate from the said audio element. As noted above, one preferred aspect of the present invention provides for the disabling of the video output which can therefore advantageously allow for the video display device of the apparatus to be switched off. This can then greatly reduce power consumption within the apparatus for periods when the audio output from the apparatus is arranged to include the audio description element in place of the video output.

According to another aspect of the present invention there is provided a method of receiving and displaying a broadcast signal comprising a video element and an audio element wherein the audio element includes an audio description element providing a description of at least some of the video content, the method including the step of switching to output to the said audio description element in place of the video element in response to a deterioration in an operating characteristic associated with the apparatus.

The method of the present invention can be arranged to include steps serving to provide for the further advantageous features of the audiovisual display apparatus as described above.

It will therefore be appreciated that the concept of the present invention allows for the consumption of, for example, broadcast TV content on, for example, a suitably enabled cellular phone and in situations when the display screen of the device should not, or cannot, be used. Such use may require limitation due to available battery power or due to aspects such as received signal quality or processing capabilities. Thus, even though such potentially disadvantageous characteristics are encountered, the user of the mobile device can nevertheless still obtain sufficient output from the device to understand and appreciate essential aspects of the video content.

With regard to still a further aspect of the invention, rather than initiating the audio description element responsive to a deterioration in an operating characteristic, the manner of operation can be monitored so as to identify, for example, movement of the apparatus. If movement is detected or movement above a threshold speed is detected, the audio description element can then be initiated. This can prove particularly useful for proving automatic switching to the audio description output in circumstances when it would be inappropriate for the user to view the apparatus for example when walking, running or driving.

The invention is described further hereinafter, by way of example only, with reference to the accompanying drawing which illustrates, in block schematic form, an embodiment of an audiovisual apparatus according to an embodiment of the present invention.

Turning now to the accompanying drawing, there is illustrated an audiovisual display apparatus which, in this particular embodiment, comprises a cellular phone 10 which has been configured so as to receive and display a broadcast television signal.

The cellular phone 10 therefore includes a display screen 12 and related drive circuitry (not shown) of suitable data handling capability so as to allow for the display of video content, and also a small speaker 14 arranged to provide for audio output from the cellular phone 10.

The display screen 12 is driven by way of a video signal from input line 16, and the speaker 14 is driven by way of an audio signal from input line 18.

The cellular phone 10 includes an antenna 20 by means of which a broadcast signal is received and then, in a standard manner, delivered to decoding and processing blocks 22, 24 which, in the illustrated example, are connected by means of data line 26.

As illustrated, the signals driving the screen 12 and speaker 14, and delivered by way of the lines 16, 18 are delivered under control from the processor 24.

Due to the mobile nature of the cellular phone 10, there is provided an onboard power supply in the form of a battery 28 which is arranged to meet the power requirement of the decoder 22 and processor 24 by way of respective power supply lines 30, 32.

The battery 28 is also arranged to provide power for the display screen 12 but, in accordance with the illustrated embodiment of the present invention, such power supply is delivered by way of line 34 via the processor 24.

The processor 24 therefore includes a switching function which provides for the disabling of the display screen 12 in a manner so as to switch-off the power supply by way of line 34 and also to prevent signals driving the display being delivered by way of line 16.

This particular embodiment of the present invention is arranged to receive a digital TV signal which also includes an audio description element within a particular channel of the broadcast signal.

Audio description is a technique employed within digital broadcasting and which serves, in particular, as an aid to users with impaired version. Such audio description broadcasting consists of an additional audio channel which is associated with the video content. The audio description contains an audio description of the actual video content so as to describe actions/motion within a particular scene of a video sequence which would not otherwise be discernible merely from passages of dialog arising within the video sequence.

Thus, within such a broadcast, there is provided an additional audio channel which can be accessed so as to provide an additional audio output over and above the dialog arising in relation to the video sequence, and which clearly describes aspects of the video output that visually impaired might not otherwise appreciate.

Within the illustrated embodiment of the present invention, such an additional audio description element is advantageous employed so as, in particular, to improve the efficiency of the cellular phone 10.

Within the processor 24 there is provided means for determining a deterioration in a particular operating characteristic of, or associated with, the cellular phone 10.

For example, the operating characteristic can comprise the quality of the video element of the signal received at antenna 20, or the actual quality of the video content that can be displayed on the screen 12. Then, if the quality of the available video element of the received signal is insufficient to provide for a suitable quality output, the screen 12 can be disabled in favour of the audio description and so as to save power.

The said characteristic can also comprise aspects relating to the internal processing of the broadcast data and which, for example, may comprise a temporary reduction in memory capacity within cellular phone 10. Then, if available memory reduces in a manner that might adversely affect the handling of the video output, the audio description can be introduced and which is ten memory intensive.

For example, an automatic switch-over to audio description can be provided when the broadcast is being stored to a local cache for later viewing and the cache capacity is too low to support a full video storage.

Should any such deterioration be determined within the processor 24, then the processor 24 is arranged to switch to provide the audio description by way of the speaker 14 and to likewise disable the display screen 12 so that both video data is not delivered thereto, and also, the screen 12 is effectively powered-down. Such measures advantageously serve to reduce the power consumption within the cellular phone 10 but in a manner that, through the enabling of the output of the audio description element, nevertheless serves to provide the user of the cellular phone 10 with an audio output compensating for the disabling of the video output.

The user's ability to therefore enjoy and follow a particular audiovisual broadcast, but without at least temporary access to the video content, can therefore be enhanced.

The illustrated embodiment employs an audio description broadcast which within Digital Video Broadcasting (DVB) systems comprises an audio description of a video scene which accompanies both video and the corresponding audio elements of the received signal.

1. An audio visual display apparatus arranged to receive a broadcast signal comprising a video element and an audio element, wherein the audio element includes an audio description element providing a description of at least some of the video content, the apparatus including means for switching to output the said audio description element in place of the video element in response to a deterioration in an operating characteristic associated with the apparatus.

2. Apparatus as claimed in claim 1 and including means for monitoring the said operating characteristics.

3. Apparatus as claimed in claim 2, wherein the said means for monitoring is arranged to monitor battery level within the apparatus.

4. Apparatus as claimed in claim 2 wherein the said means for monitoring the characteristic is arranged to monitor data-handling capacity within the apparatus.

5. Apparatus as claimed in claim 4, wherein the means for monitoring is arranged to monitor memory capacity.

6. Apparatus as claimed in claim 3, wherein the said means for monitoring the operating characteristic is arranged to monitor the quality of the broadcast signal as received at the apparatus.

7. Apparatus as claimed in claim 6, wherein the means for monitoring the characteristic arranged to monitor the picture quality of the video element.

8. Apparatus as claimed in claim 1 and comprising a mobile radio communications device.

9. A method of receiving and displaying a broadcast signal comprising a video element and an audio element wherein the audio element includes an audio description element providing a description of at least some of the video content, the method including the step of switching to output the said audio description element in place of the video element in response to a deterioration in an operating characteristic associated with the apparatus.

10. A method as claimed in claim 9 and including the step of monitoring the said operating characteristic.

11. A method as claimed in claim 10 and including the step of monitoring battery level within the apparatus.

12. A method as claimed in claim 10, and including the step of data handling capacity within the apparatus.

13. A method as claimed in claim 12, and including the step of memory capacity.

14. A method as claimed in claim 10, and including the step of monitoring the quality of the broadcast signal as received at the apparatus.

15. A method as claimed in claim 12 and including the step of monitoring picture quality.
